(19) United States
(12) Patent Application Publication
(10) Pub. No.: US 2010/0027194 A1
(43) Pub. Date: Feb. 4, 2010

(54) SOLID ELECTROLYTIC CAPACITOR

(75) Inventors: Taeko Ota, Takatsuki City (JP); Masayuki Fujita, Kyoto City (JP); Hiroyuki Watanabe, Ichinomiya City (JP)

Correspondence Address: MOTS LAW, PLLC, 1629 K STREET N.W., SUITE 602, WASHINGTON, DC, 20006-1635, US

(73) Assignee: SANYO ELECTRIC CO., LTD, Moriguchi City (JP)

(21) Appl. No.: 12/512,611

(22) Filed: Jul. 30, 2009

(30) Foreign Application Priority Data
Jul. 30, 2008 (JP) 2008-196368

(51) Int. Cl. H01G 9/025

(52) U.S. Cl. 361/523

(57) ABSTRACT

An aspect of the invention provides a solid electrolytic capacitor that comprises: a capacitor element comprising: an anode; a dielectric layer formed above the anode; an electrolyte layer formed above the dielectric layer; and a cathode layer formed above the electrolyte layer; an anode lead frame electrically connected to the anode; a cathode lead frame electrically connected to the capacitor element; and a conducting adhesive layer, containing thermally expandable graphite. Electric current flows through the capacitor element to the conducting adhesive layer.

### CROSS REFERENCE TO RELATED APPLICATIONS

This application claims priority based on 35 USC 119 from prior Japanese Patent Application No. P2008-196368 filed on Jul. 30, 2008, entitled “SOLID ELECTROLYTIC CAPACITOR”, the entire contents of which are incorporated herein by reference.

### BACKGROUND OF THE INVENTION

1. Field of the Invention

The invention relates to a solid electrolytic capacitor having a capacitor element including an anode, a dielectric layer, an electrolyte layer and a cathode layer.

2. Description of Related Art

Solid electrolytic capacitors are used in a variety of circuits such as CPU power supply circuits or other related circuits. They are widely used in various personal digital assistants such as computers and cellular phones and various visual information devices such as digital cameras and other electronic devices.

In the event of an improper connection or a malfunction while using devices containing solid electrolytic capacitors, burnout of surrounding parts or printed circuit boards may occur because the capacitor element can generate heat or ignite due to high short-circuit current flow. Therefore, the prevention of solid electrolytic capacitor burnout due to extremely high short-circuit current flow has been contemplated in recent years.

For example, a solid electrolytic capacitor with contained a fuse for a technique to prevent solid electrolytic capacitor burnout is known. The fuse is placed between the capacitor element and the terminal post to which it is connected; the fuse is sealed in an outer resin layer. In such solid electrolytic capacitor with contained fuse, the fuse is placed between the capacitor element and the terminal post. When extremely high short-circuit current flows into the capacitor element; the fuse melts to open the electrical circuit, stopping electric current and preventing solid electrolytic capacitor burnout.

However, existing solid electrolytic capacitors with contained fuse have issues with shutting down of the electric current completely as the device configuration becomes more complicated.

Another solid electrolytic capacitor that can regulate electric current at a low temperature is known. The capacitor has an electric current regulating layer formed with insulating polymer entrained conducting particles; the layer is placed between the capacitor element and the lead frame connected to it.

However, these solid electronic capacitors aim to control the current at a low temperature.

Furthermore, a method to manufacturing thermally expandable graphite that expands its volume above a predetermined temperature is known.

### SUMMARY OF THE INVENTION

An aspect of the invention provides a solid electrolytic capacitor that comprises: a capacitor element comprising: an anode; a dielectric layer formed above the anode; an electrolyte layer formed above the dielectric layer; and a cathode layer formed above the electrolyte layer; an anode lead frame electrically connected to the anode; a cathode lead frame electrically connected to the capacitor element; and a conducting adhesive layer, containing thermally expandable graphite. Electric current flows through the capacitor element to the conducting adhesive layer.

The above-described solid electrolytic capacitor has at least one conducting adhesive layer containing thermally expandable graphite in at least one of the following current paths: anode lead frame to capacitor element; capacitor element to cathode lead frame. The thermally expandable graphite contained in the conducting adhesive layer has the property of expanding its cubic volume when the temperature reaches a prescribed temperature. When the thermally expandable graphite expands at the prescribed temperature, it creates a space within the conducting adhesive layer and interrupts electric current flowing within the conducting adhesive layer. Forming the conducting adhesive layer in an electric path, wherein the electric current flows into capacitor element, enables secure interruption of the electric current. When extremely high short-circuit current flows into the capacitor element, its temperature increases thereby opening the electric circuit and interrupting the electric current completely. Hence, it dependably prevents solid electrolytic capacitor burnout.

Preferably, the heat expansion onset temperature of the thermally expandable graphite is set in the range of 300-400 degrees Celsius. When the solid electrolytic capacitor is soldered onto a printed circuit board, it is possible that it could be heated up to 300 degrees Celsius. If the heat expansion onset temperature is lower than 300 degrees Celsius the capacitor may break down during the soldering process. Furthermore, if the heat expansion onset temperature is higher than 400 degrees Celsius the capacitor element may ignite before the thermally expandable graphite expands to interrupt the electric current.

In addition, it is preferable that the thermally expandable graphite percentage content in the conducting adhesive layer is in the range within 5-30%. When the thermally expandable graphite content percentage is too high, the conductivity of the conducting adhesive layer decreases and the solid electrolytic capacitor performance may deteriorate. On the other hand, when thermally expandable graphite content percentage is too low, even though the thermally expandable graphite expands, it may not open the electric circuit to interrupt the electric current.

### BRIEF DESCRIPTION OF THE DRAWING

FIG. 1 is a cross-sectional block diagram of a solid electrolytic capacitor in an embodiment.

FIG. 2 is a cross-sectional view taken along sectional line (a) of FIG. 1.

FIG. 3 is a cross-sectional block diagram of a solid electrolytic capacitor in another embodiment.

FIG. 4 is a cross-sectional view taken along sectional line (b) of FIG. 3.

FIG. 5 is a cross-sectional block diagram of a solid electrolytic capacitor in yet another embodiment.

### DETAILED DESCRIPTION OF EMBODIMENTS

Descriptions are provided for embodiments based on the drawings. In the respective drawings referenced herein, the same constituents are designated by the same reference numerals and duplicate explanation concerning the same constituents is omitted. All of the drawings are provided to illustrate the respective examples only. No dimensional proportions in the drawings shall impose a restriction on the embodiments. For this reason, specific dimensions and the like should be interpreted with the following descriptions taken into consideration. In addition, the drawings include parts whose dimensional relationship and ratios are different from one drawing to another.

Prepositions, such as “on”, “over” and “above” may be defined with respect to a surface, for example a layer surface, regardless of that surface's orientation in space. The preposition “above” may be used in the specification and claims even if a layer is in contact with another layer. The preposition “on” may be used in the specification and claims when a layer is not in contact with another layer, for example, when there is an intervening layer between them.

### EXPERIMENTAL TRIAL 1

### Embodiment 1

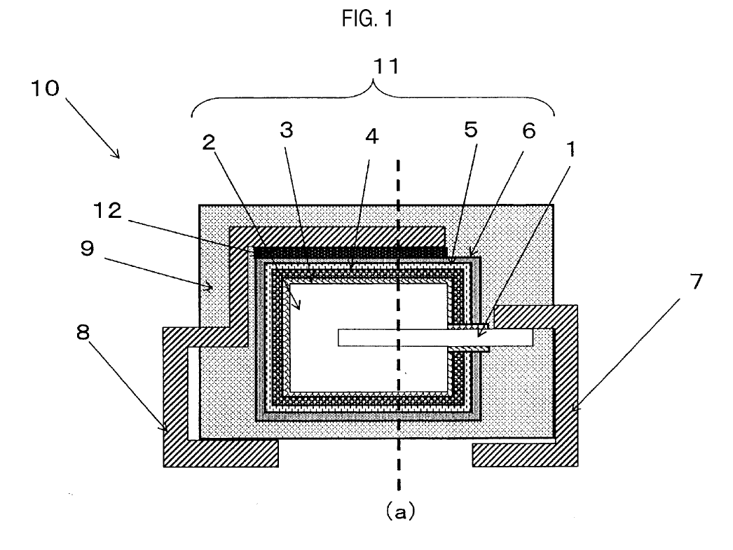

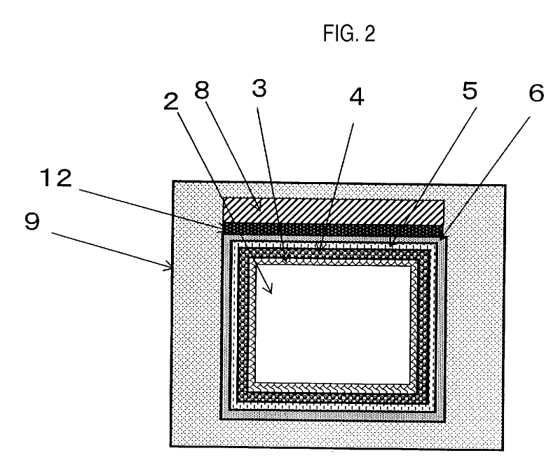

FIG. 1 is a cross-sectional block diagram of a solid electrolytic capacitor in embodiment 1. FIG. 2 is a cross-sectional view taken along sectional line (a) of FIG. 1.

As shown in FIG. 1, solid electrolytic capacitor 10 comprises a layered arrangement of dielectric layer 3, electrolyte layer 4, carbon layer 5 and silver paste layer 6 formed in that order on the surface of anode 2.

Anode 2 is a porous sintered body of valve metal or valve metal alloy. Dielectric 3 is formed by oxidation, such as anode-oxidation, of the surface of the porous sintered body. Hence, dielectric layer 3 is formed inside of the porous body of anode 2 as well.

Electrolyte layer 4 is formed on dielectric layer 3. Electrolyte layer 4 can be comprised of conducting polymer, for example, polypyrrole, polythiophene and etc. Since electrolyte layer 4 is formed on dielectric layer 3, it is formed inside of the porous body of anode 2 as well.

Anode lead wire 1 is embedded in the central part of anode 2. When anode 2 is formed and sintered, anode lead wire 1 can be embedded in anode 2 by insertion of a wire rod of valve metal or alloyed metal while forming the sintered body.

Carbon layer 5 is formed on electrolyte layer 4 on the surface of the outer circumference of anode 2. Carbon layer 5 can be formed by a coating of carbon paste. Silver paste layer 6 is formed on top of carbon layer 5. Silver paste layer 6 can be formed by a coating of silver paste containing silver particles.

In this embodiment, a cathode layer encloses carbon layer 5 and silver paste layer 6. Silver paste layer 6 and cathode lead frame 8 are connected by conducting adhesive layer 12, which contains the thermally expandable graphite. Furthermore, anode lead wire 1 is connected by welding to anode lead frame 7. Resin mold 9 is formed so that the end terminals of anode lead frame 7 and cathode lead frame 8 terminate to the exterior of the assembly.

Capacitor element 11 encloses anode 2, dielectric layer 3, electrolyte layer 4, carbon layer 5 and silver paste layer 6.

Conducting adhesive layer 12 contains the thermally expandable graphite. When capacitor element 11 experiences extremely high short-circuit current, heat is generated. Due to the heat, the thermally expandable graphite contained in conducting adhesive layer 12 reaches the onset temperature and begins thermal expansion. Due to the expansion of the thermally expandable graphite, an open space is created inside of conducting adhesive layer 12. Hence, the conducting adhesive layer loses the capability to conduct electricity and electric current flow to the capacitor element 11 stops. Thus, ignition of capacitor element 11 is prevented.

The thermally expandable graphite can be created by mixing solid neutralizer after processing the raw graphite in a mixture of sulfuric acid and an oxidizing agent. For the material comprising the thermally expandable graphite, graphite such as natural graphite, pyrolytic graphite and Kish graphite can be used. For sulfuric acid, concentrated sulfuric acid, anhydrous sulfate, fuming sulfuric acid and the like can be used. Furthermore, the following can be used for the oxidizing agent: peroxide, such as hydrogen peroxide, ammonium peroxide and potassium peroxide; nitric acid, such as persulfate, concentrated nitric acid and fuming nitric acid; perchloric acid; and perchlorate. Here, it is preferable to use about 1-10 wt % of oxidizing agent per 100 wt % of sulfuric acid.

As for solid neutralizer, oxidative products of alkali earth metals, hydroxide, carbonate and such can be used. An example of preferable usage amount of solid neutralizers is: 40-100 wt % of calcium carbonate per 100 wt % of sulfuric acid. Another example of preferable usage amount of solid neutralizers is: 40-90 wt % of magnesium hydrate per 100 wt % of sulfuric acid.

The solid electrolytic capacitor in the embodiment described above, is created specifically as follows: first, tantalum powder with average particle sized of roughly 2 μm, is shaped in the form of a plate covering a part of the anode lead wire. Then, it is sintered in a vacuum tube. Anode 2 is formed to have the above mentioned anode lead wire 1 imbedded in its core.

In a next step, anode 2 is soaked in roughly 0.1 wt % phosphoric acid aqueous solution, which is kept at a temperature of approximately 60 degrees Celsius. It is anodically-oxidized under a fixed electrical voltage of 8V for approximately 10 hours. This step creates dielectric layer 3, which is made of tantalum oxide on the surface of anode 2. As mentioned above, dielectric layer 3 is also formed inside of porous solid anode 2.

In a next step, monomer solution is created by dissolving 10 wt % pyrrole as polymerizable monomer, 16 wt % p-Toluenesulfonic acid iron (III), as a dopant projector as well as an oxidation agent, and mixed solution of ethanol and water (volume ratio 5:1). Anode 2, which has formed dielectric layer 3 in it, is left in the air for 2 hours after being soaked in above-mentioned monomer solution. After the above steps, electrolyte layer 4 is formed on dielectric layer 3. The thickness of electrolyte layer 4 is approximately 100 μm.

In a next step, carbon paste is applied on electrolyte layer 4, which surrounds outer circumference of anode 2. After it is dehydrated for 30 minutes at 150 degrees Celsius (° C.), carbon layer 5 is formed. Then silver paste is applied on top of carbon layer 5. Silver paste layer 6 is formed after it is dehydrated for 30 minutes at 170 degrees Celsius.

Capacitor element 11 is formed by the above steps.

Next, conducting adhesive formulation paste is made as follows: thermally expandable graphite is mixed with the same silver paste material which is used to create silver paste layer 6. The amount of thermally expandable graphite, with a heat expansion onset temperature of 250 degrees Celsius and an expansion ratio at that temperature of 20 cm³/g, is adjusted to 10 wt % of the conducting adhesive layer 12. This conducting adhesive formulation paste is applied on silver paste layer 6. After cathode lead frame 8 is placed on it, it is dehydrated for 2 hours at 150 degrees Celsius under reduced pressure of 1*10² Pa. Cathode lead frame 8 and silver paste layer 6 are thereby attached with conducting adhesive layer 12 by above process.

In the embodiment, the heat expansion onset temperature of the thermally expandable graphite can be determined by the following procedure. First, a 1 g sample of thermally expandable graphite is put in a scaled 12 ml glass cylinder. The glass cylinder is placed in an electric furnace to elevate the temperature. The temperature is elevated 5 degrees Celsius per minute from a starting temperature of 150 degrees Celsius. Cubic measurements of the glass cylinder content are measured and recorded periodically as the temperature rises at every 5 degrees Celsius. The heat expansion onset temperature is determined as the temperature when the cubic measurement of the thermally expandable graphite is 1.1 times or more that of the original cubic volume.

Furthermore, the conducting adhesive layer in the embodiment can be formed by application of the conducting adhesive paste. The conducting adhesive paste can be created as a uniform mixture of the thermally expandable graphite and conducting paste containing conducting particles such as silver particles.

As shown FIG. 2, conducting adhesive layer 12 is formed to cover the entire contacting surface of silver paste layer 6 and cathode lead frame 8.

Anode lead frame 7 is attached to anode lead wire 1 by welding.

Next, the surface of capacitor element 11 is coated with resin mold while the end terminals of anode lead frame 7 and cathode lead frame 8 are pulled out to the exterior. As described above, mold resin 9 is formed and solid electrolytic capacitor 10 is created.

The cross-sectional surface of developed solid electrolytic capacitor 10 is examined with a transmission electron microscope. The thickness of conducting layer 12 is measured as approximately 50 μm in the embodiment.

Furthermore, the expansion rate of the thermally expandable graphite can be determined as follows.

A 150 ml quartz glass beaker is placed and kept more than 5 minutes in an electric furnace, which is kept at a set temperature. The beaker is removed from the electrical furnace, 0.5 g of thermally expandable graphite is added, and it is immediately returned to the furnace. The electric furnace is kept in a set temperature. After keeping the beaker in it for 10 seconds, the beaker is removed once again. After standing to cool, cubic measurement of expansion is measured by using the beaker scale readout. The expansion rate at the set temperature can be determined from increased expansion cubic measurement (cm³/g) per sample weight.

### Embodiment 2

The solid electrolytic capacitor of embodiment 2 has the same configuration as embodiment 1 except for the following settings: the heat expansion onset temperature is set at 300 degrees Celsius; the expansion rate, at that temperature, of the thermally expandable graphite is 20 cm³/g.

### Embodiment 3

The solid electrolytic capacitor of embodiment 3 has the same configuration as embodiment 1 except for the following settings: the heat expansion onset temperature is set at 350 degrees Celsius; the expansion rate, at that temperature, of the thermally expandable graphite is 20 cm³/g.

### Embodiment 4

Solid electrolytic capacitor of embodiment 4 has the same configuration as embodiment 1 except for the following settings: the heat expansion onset temperature is set at 400 degrees Celsius; the expansion rate, at that temperature, of the thermally expandable graphite is 20 cm³/g.

### Embodiment 5

The solid electrolytic capacitor of embodiment 5 has the same configuration as embodiment 1 except for the following settings: the heat expansion onset temperature is set at 450 degrees Celsius; the expansion rate, at that temperature, of the thermally expandable graphite is 20 cm³/g.

### Comparative Example 1

The solid electrolytic capacitor of comparative example 1 has the same configuration as embodiment 1 except for the following condition: conducting adhesive layer 12 is formed from silver paste without adding thermally expandable graphite.

### Comparative Example 2

The solid electrolytic capacitor of comparative example 2 has the same configuration as embodiment 1 except for the following condition: instead of forming conducting adhesive layer 12, cathode lead frame 8 is placed directly on silver paste layer 6; and silver paste layer 6 and cathode lead frame 8 are connected with a gold wire (wire diameter 50 μm).

(Measurement of Capacitance)

Capacitances of the solid electrolytic capacitors of the above embodiments 1-5 and comparative examples 1 and 2 were measured. After the respective sold electrolytic capacitors were manually mounted on printed circuit boards with a soldering gun to avoid overheating them, capacitances were measured at a frequency 120 Hz. Measurement results are shown in table 1. The amount of capacitance in table 1 is normalized to the observed value of comparative example 1 of 100.

### (Confirmatory Trial of Fuse Function)

The fuse functions of the solid electrolytic capacitors as configured in embodiments 1-5 and comparative examples 1 and 2 were verified as follows. After the respective sold electrolytic capacitors were manually mounted on printed circuit boards with a soldering gun to avoid overheating them, an overvoltage of 16V, which is twice that of anode oxidation voltage, is applied. After the capacitor element is short-circuited due to above overvoltage, continuity of the electric circuits was determined by applying a 5 A overcurrent. Also, release of smoke or ignitions of capacitors are observed. The numbers of observed samples was 100 and the number of opened circuits and the number of capacitors that release fumes or ignition are recorded. The measurement results are shown in table 1. Application of a 16V overvoltage and 5 A overcurrent is an extreme condition, which cannot be achieved in regular usage of the solid electrolytic capacitors.

Furthermore, element occupancy rates are calculated and shown in table 1. Element occupancy rate is the ratio of cubic volume of the capacitor element to the cubic volume of the solid electrolytic capacitor.

TABLE 1

| | Heat expansion | | | Numbers of | Release | | |
|---|---|---|---|---|---|---|---|
| | onset temperature of | | Examination | circuit opening | of fume | Ignition | Element |
| | thermally expandable | | (Numbers | (Numbers | (Numbers | (Numbers | Occupancy |
| | graphite (Celsius) | Capacitance | of pieces) | of pieces) | of pieces) | of pieces) | (%) |
| Embodiment 1 | 250 | 100 | 100 | 100 | 0 | 0 | 35 |
| Embodiment 2 | 300 | 100 | 100 | 100 | 0 | 0 | 35 |
| Embodiment 3 | 350 | 100 | 100 | 100 | 0 | 0 | 35 |
| Embodiment 4 | 400 | 100 | 100 | 100 | 0 | 0 | 35 |
| Embodiment 5 | 450 | 100 | 100 | 100 | 6 | 0 | 35 |
| Comparative | — | 100 | 100 | 0 | 100 | 100 | 35 |
| Example 1 | | | | | | | |
| Comparative | — | 100 | 100 | 87 | 13 | 9 | 10 |
| Example 2 | | | | | | | |

As the results in table 1 clearly show, all 100 of the solid electrolytic capacitors in embodiments 1-5 exhibited opened circuits. Compared to the solid electrolytic capacitors in comparative examples 1 and 2, the solid electrolytic capacitors of embodiments 1-5 have a better fuse function, which securely cut off current when overcurrent is applied. Due to the conducting adhesive layer containing the thermally expandable graphite, when overcurrent is applied and the capacitor element temperature increases, the thermally expandable graphite in the conducting adhesive layer expands its volume, thereby creating an open circuit within the conducting adhesive layer. Thus, this function can securely interrupt electric current flow to capacitor element. As shown in table 1 for comparative example 2, which is the conventional solid electrolytic capacitor with internal fuse, the number of opened circuits is 87. Current flow into the capacitor element is not consistently interrupted.

Furthermore, element occupancy rates in embodiments 1-5 are higher than the rate for the solid electrolytic capacitors with internal fuses in comparative example 2. Also, element occupancy rates in embodiments 1-5 are similar to those of the solid electrolytic capacitors without an internal fuse in comparative example 1. Therefore, the solid electrolytic capacitors in embodiments 1-5 of the invention can interrupt electric current when the capacitor element experiences extremely high short-circuit current. This is achieved virtually without volume increase.

As shown in table 1, some of the sample solid electrolytic capacitors of embodiment 5 did emitted fumes. In embodiment 5, the heat expansion onset temperature of the thermally expandable graphite was set as 450 degrees Celsius. Due to high temperature, it is assumed that the capacitance element started to emit fumes before the thermally expandable graphite start expanding to interrupt the current.

In addition, another set of solid electrolytic capacitors configured as in embodiments 1-5 and comparative examples 1 and 2 were assembled on printed circuit boards with a reflow soldering method.

The same tests as above were run using these solid electrolytic capacitors with. The soldering method used is the reflow method, with a temperature of over 260 degrees Celsius for 10 seconds. In the results for the solid electrolytic capacitors of embodiment 1, capacitance measurements are unavailable. Those solid electrolytic capacitors were assembled with the reflow soldering method at a temperature of 260 degrees Celsius and a heat expansion onset temperature of the thermally expandable graphite of 250 degrees Celsius. Hence, trial failure is assumed to be due to capacitor damage caused when the thermally expandable graphite expanded during reflow soldering. The results of the other embodiments 2-5 and comparative examples 1 and 2 are similar to the results as above in table 1.

From above experiments, it is preferable to set the heat expansion onset temperature of the thermally expandable graphite in the range 300-400 degrees Celsius.

### EXPERIMENTAL TRIAL 2

In experimental trial 2, the effect of content ratio of the thermally expandable graphite in the conducting adhesive layer is studied. In this experimental trial, the thermally expandable graphite used in embodiment 2 is studied. (Heat heat expansion onset temperature: 300 degrees Celsius, thermal expansivity at that temperature: 20 cm³/g)

### Embodiment 6

The solid electrolytic capacitor of embodiment 6 has the same configuration as embodiment 1 except that the amount of thermally expandable graphite in the conducting adhesive layer is set at 2.5 wt %.

### Embodiment 7

The solid electrolytic capacitor of embodiment 7 has the same configuration as embodiment 1 except that the amount of thermally expandable graphite in the conducting adhesive layer is set at 5 wt %.

### Embodiment 8

The solid electrolytic capacitor of embodiment 8 has the same configuration as embodiment 1 except the amount of the thermally expandable graphite in the conducting adhesive layer is set at 10 wt %.

### Embodiment 9

The solid electrolytic capacitor of embodiment 9 has the same configuration as embodiment 1 except that the amount of the thermally expandable graphite in the conducting adhesive layer is set at 30 wt %.

### Embodiment 10

The solid electrolytic capacitor of embodiment 10 has the same configuration as embodiment 1 except that the amount of thermally expandable graphite in conducting adhesive layer is set at 35 wt %.

### (Measurement of ESR)

The solid electrolytic capacitors configured as in embodiments 6-10 and comparative example 1 were assembled on printed circuit boards with the reflow soldering method. ESR at a frequency 100 kHz were measured respectively. ESR is measured by using an LCR meter and applying voltage between anode lead frame 7 and cathode lead frame 8.

Measurement results are shown in table 2. The value of ESR is normalized when measurement of comparative example 1 is 100.

### (Confirmatory Trial of Fuse Function)

The fuse function of the solid electrolytic capacitors configured in embodiments 6-10 and comparative example 1 were verified as follows. After the sold electrolytic capacitors were mounted on the printed circuit boards with the reflow soldering method, overvoltage of 16V, which is twice of anode oxidation voltage, was applied. After the capacitor elements were short-circuited due to that overvoltage, the continuity of the electric circuits was observed with an overcurrent of 5 A applied. The numbers of observed samples in this experimental trial was 100; results are shown in table 2.

The reflow soldering time length at a temperature of over 260 degree Celsius was set at 10 seconds and was held there twice.

TABLE 2

| | Contained | | | Numbers of |
|---|---|---|---|---|
| | amount of | | | circuit |
| | thermally | | Examination | opening |
| | expandable | | (Numbers of | (Numbers of |
| | graphite (wt %) | ESR | pieces) | pieces) |
| Embodiment 6 | 2.5 | 100 | 100 | 95 |
| Embodiment 7 | 5 | 100 | 100 | 100 |
| Embodiment 8 | 10 | 100 | 100 | 100 |
| Embodiment 9 | 30 | 100 | 100 | 100 |
| Embodiment 10 | 35 | 104 | 100 | 100 |
| Comparative | — | 100 | 100 | 0 |
| Example 1 | | | | |

As the results in table 2 indicate, the number of opened circuits of embodiment 6 is 95. The amount of the thermally expandable graphite was 2.5 wt % in embodiment 6. This result indicates that when the amount of the thermally expandable graphite in the conducting adhesive layer is too low, the electric circuit may fail to open even though the thermally expandable graphite expands.

In embodiment 10, the amount of thermally expandable graphite was 35 wt % and ESR takes a slightly higher value of 104. The result indicates that the solid electrolytic capacitor performance decreases due to electrical low conductivity when the amount of thermally expandable graphite is high.

The result of the above experimental trial indicates the preferable contained amount of thermally expandable graphite in the conducting adhesive layer is in the range of 5-30 wt %.

### Other Embodiments

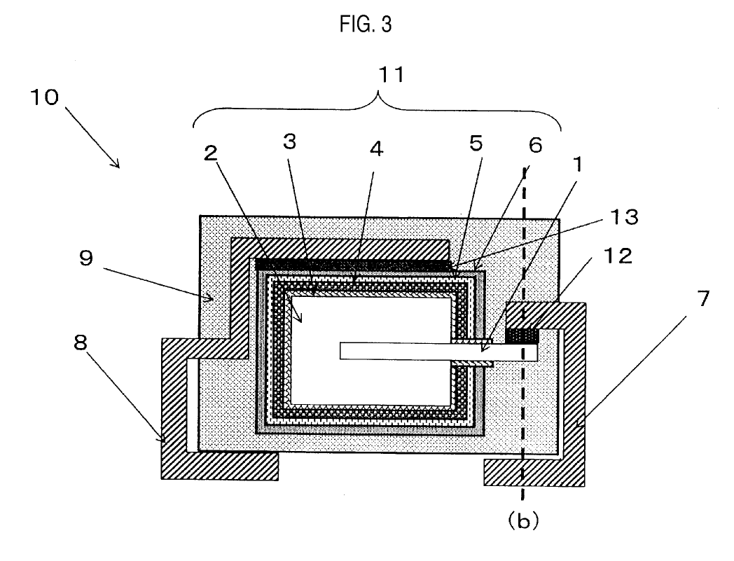

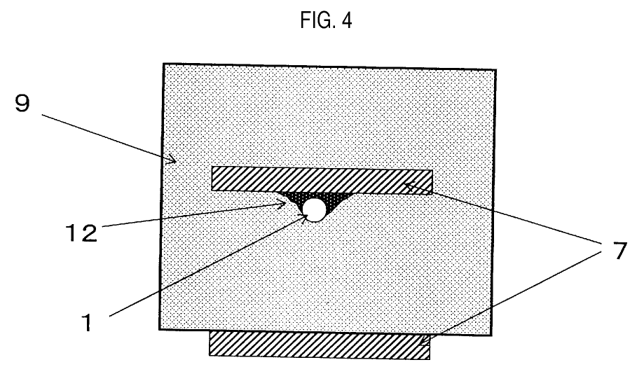

FIG. 3 is a cross-sectional block diagram of a solid electrolytic capacitor in another embodiment. FIG. 4 is a cross-sectional view taken along sectional line (b) of FIG. 3.

In this embodiment, the thermally expandable graphite is not contained in the conducting adhesive layer 13 formed between silver paste layer 6 of capacitor element 11 and cathode lead frame 8. That is, the conducting adhesive layer 13 is formed from the silver paste without the thermally expandable graphite.

Furthermore in this embodiment, anode lead wire 1 of anode 2 and anode lead frame 7 are connected with conducting adhesive layer 12 containing thermally expandable graphite. As shown in FIG. 4, anode lead frame 7, which is connected to anode lead wire 1, is shaped in the form of a plate. Conducting adhesive layer formulation paste containing thermally expandable graphite is applied first on top of the plate. Anode lead wire 1 is pressed on top of it and then dried for 2 hours at 150 degrees Celsius under reduced pressure of 1*10² Pa. Subsequently, anode lead frame 7 and anode lead wire 1 are connected with conducting adhesive layer 12.

As shown FIG. 3, electric current flow into capacitor element 11 can be securely interrupted when anode wire 1 and anode lead frame 7 are electrically connected with conducting adhesive layer 12, which contains thermally expandable graphite. When capacitor element 11 experiences extremely high short-circuit current, the temperature of conducting adhesive layer 12 increases due to capacitor element 11 heat emission. As a result, a space is formed inside of conducting adhesive layer 12 and current is securely interrupted.

In addition, conducting adhesive layer 13 shown in FIG. 3 is also considered [to function] as conducting adhesive layer 12, which contains thermally expandable graphite. Furthermore, conducting adhesive layer 12 that has two fuse functions can be used as well.

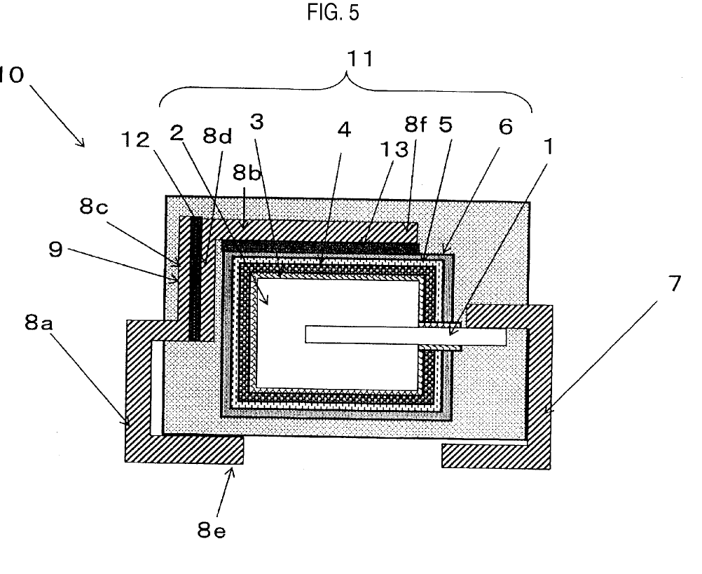

FIG. 5 is a cross-sectional block diagram of a solid electrolytic capacitor in yet another embodiment. In this embodiment, the cathode lead frame is divided into two parts: allocated lead frame 8a and allocated lead frame 8b. The end parts of allocated lead frames 8a and 8b are indicated as 8c and 8d. Conducting adhesive layer 12 containing thermally expandable graphite is formed between 8c and 8d. Therefore, the electric current path including the cathode lead frame is by allocated lead frame 8a and 8b, and conducting adhesive layer 12 intervening between them.

Conducting adhesive layer 13, which does not contain thermally expandable graphite, is formed between Silver paste layer 6 of capacitor element 11 and allocated lead frame 8b. The other side of allocated lead frame 8a is indicated as 8e. It is connected to a relay terminal of solid electrolytic capacitor 10. The other side of allocated lead frame 8b is indicated as 8f and it is connected to conducting adhesive layer 13.

As described in the embodiment, the cathode lead frame is divided into two parts and conducting adhesive layer 12 containing thermally expandable graphite is formed between 8a and 8b. The electric current flowing into capacitor element 11 can be securely interrupted when extremely high short-circuit current flows into capacitor element 11 in the same manner as above embodiments. Hence, burn damage of the solid electrolytic capacitor can be prevented without fail.

Furthermore in this embodiment, conducting adhesive layer 13 can be replaced with conducting adhesive layer 12, which contains thermally expandable graphite. In addition, conducting adhesive layer 12, which contains thermally expandable graphite, can connect electrically between anode lead wire 1 and anode lead frame 7 as in the embodiment shown in FIG. 3.

In the above embodiment, the cathode lead frame is allocated into two parts, but the anode lead frame also can have conducting adhesive layer, which contains thermally expandable graphite. Furthermore, three or more allocations can be created and conducting adhesive layers, which contain thermally expandable graphite, can be formed between them.

As described in the above embodiments, the solid electrolytic capacitor interrupts the current by opening the electric circuit when the capacitor element receives extremely high electric current.

The invention includes other embodiments in addition to the above-described embodiments without departing from the spirit of the invention. The embodiments are to be considered in all respects as illustrative, and not restrictive. The scope of the invention is indicated by the appended claims rather than by the foregoing description. Hence, all configurations including the meaning and range within equivalent arrangements of the claims are intended to be embraced in the invention.

What is claimed is:

1. A solid electrolytic capacitor comprising:
a capacitor element comprising:
an anode;
a dielectric layer formed above the anode;
an electrolyte layer formed above the dielectric layer; and
a cathode layer formed above the electrolyte layer;
an anode lead frame electrically connected to the anode;
a cathode lead frame electrically connected to the capacitor element; and
a conducting adhesive layer, containing thermally expandable graphite and placed on a current path between the capacitor element and the cathode lead frame, wherein electric current flows through the capacitor element to the conducting adhesive layer.

2. The solid electrolytic capacitor of claim 1, wherein the conducting adhesive layer is formed between the capacitor element and the cathode lead frame.

3. The solid electrolytic capacitor of claim 1, wherein the cathode lead frame is electrically divided in parts, wherein the conducting adhesive layer is formed between the electrically divided cathode lead frames.

4. The solid electrolytic capacitor of claim 1, wherein a heat expansion onset temperature of the thermally expandable graphite is in a range of 300 degrees Celsius and 400 degrees Celsius.

5. The solid electrolytic capacitor of claim 1, wherein the level of the thermally expandable graphite content in the conducting adhesive layer is in a range of 5-30 percent by weight.

6. The solid electrolytic capacitor of claim 1, wherein the thermally expandable graphite contains at least one of the following graphite: natural graphite; pyrolytic graphite and Kish graphite.

7. The solid electrolytic capacitor of claim 1, wherein the conducting adhesive layer has contact with the capacitor element.

8. The solid electrolytic capacitor of claim 1, wherein the conducting adhesive layer has contact with the cathode lead frame and does not have contact with the capacitor element.

9. The solid electrolytic capacitor of claim 1, further comprising:
a conducting adhesive layer, containing thermally expandable graphite and placed on a current path between the anode lead frame and the capacitor element, wherein electric current flows through the capacitor element to the conducting adhesive layer.

10. The solid electrolytic capacitor of claim 1, wherein the conducting adhesive layer is a silver paste layer containing thermally expandable graphite.

11. A solid electrolytic capacitor comprising:
a capacitor element comprising:
an anode;
a dielectric layer formed above the anode;
an electrolyte layer formed above the dielectric layer; and
a cathode layer formed above the electrolyte layer;
an anode lead frame electrically connected to the anode;
a cathode lead frame electrically connected to the capacitor element; and
a conducting adhesive layer, containing thermally expandable graphite and placed on a current path between the anode lead frame and the capacitor element, wherein electric current flows through the capacitor element to the conducting adhesive layer.

12. The solid electrolytic capacitor of claim 11, wherein the conducting adhesive layer is formed between the anode lead frame and the capacitor element.

13. The solid electrolytic capacitor of claim 11, wherein the cathode lead frame is electrically divided in parts, wherein the conducting adhesive layer is formed between the electrically divided anode lead frames.

14. The solid electrolytic capacitor of claim 11, wherein a heat expansion onset temperature of the thermally expandable graphite is in a range of 300 degrees Celsius and 400 degrees Celsius.

15. The solid electrolytic capacitor of claim 11, wherein the level of the thermally expandable graphite content in the conducting adhesive layer is in a range of 5-30 percent by weight.

16. The solid electrolytic capacitor of claim 11, further comprising an anode lead wire electrically connected to the anode and anode lead frame, wherein the conducting adhesive layer has in contact with the anode lead wire.

17. The solid electrolytic capacitor of claim 16, wherein the conducting adhesive layer has contact with the anode lead frame and does not have contact with the anode lead wire.

18. The solid electrolytic capacitor of claim 11, wherein the conducting adhesive layer is a silver paste layer containing thermally expandable graphite.
